(19) United States
(12) Patent Application Publication
(10) Pub. No.: US 2010/0259356 A1
(43) Pub. Date: Oct. 14, 2010

(54) Thermostat

(75) Inventor: HaeYang Chung, Gyeonggi-do (KR)

Correspondence Address: Stevens Law Group, 1754 Technology Drive, Suite #226, San Jose, CA, 95110, US

(73) Assignee: Hanbecthistem Co., Ltd., Gyeonggi-do (KR)

(21) Appl. No.: 12/732,089

(22) Filed: Mar. 25, 2010

(30) Foreign Application Priority Data
Apr. 10, 2009 (KR) 10-2009-0031125
Oct. 30, 2009 (KR) 10-2009-0104447
Feb. 4, 2010 (KR) 10-2010-0010242

(51) Int. Cl. H01H 37/52

(52) U.S. Cl. 337/334

(57) ABSTRACT

Disclosed is a thermostat comprising: a housing; first and second switching sections installed within the housing; a bimetal installed within the housing to electrically insulate the first and second switching sections at a predetermined temperature; and upper and lower caps covering upper and lower opened ends of the housing. According to the thermostat, the first and second switching sections are controlled to simultaneously block a plurality of input terminals.

### CROSS-REFERENCE TO RELATED APPLICATION

This application claims priority to and the benefit of Korean Patent Application No. 2009-0031125, filed on Apr. 10, 2009 and Korean Patent Application No. 2009-0104447, filed on Oct. 30, 2009 and Korean Patent Application No. 2010-0010242, filed on Feb. 4, 2010, the disclosures of which are incorporated herein by reference in its entirety.

### BACKGROUND

1. Field of the Invention

The present invention relates to a thermostat, and more particularly to a thermostat that controls an operation of simultaneously blocking a plurality of input terminals and ensures both prevention of overheating and precise control of temperature.

2. Discussion of Related Art

In general, although electrical devices are safely operated by a certain range of currents or within a certain range of temperatures during a normal operation, they may be damaged or cause a fire due to overheating when an over-current is supplied to them or they are overheated by an abnormal operation.

In order to solve the above problems, as illustrated in FIG. 1, a conventional thermostat 10 includes a conductive plate 1 having a fixed contact point 2 on one surface thereof and a first connecting terminal 3 on one side thereof, a bimetal 6 having a movable contact point 8 contactable with the fixed contact point 2 formed in the conductive plate 1 at one end thereof, a can 4 made of a conductive material and having a second connecting terminal 5 on one side thereof, the other end of the bimetal being fixed to an inner side surface of the can 4, a first insulting plate 12 attached to a lower surface of the conductive plate 1, a second insulating plate 13 attached to contact portions between the can 4 and the conductive plate 1 to electrically insulate them from each other, a base 11 attached to a lower surface of the first insulating plate 12, and an adjustor 17 protruding downward from the can 4 toward the bimetal 6 to push a middle portion of the bimetal 6 by a predetermined displacement.

However, since the thermostat 10 has a single fixed contact point 2 and a single movable contact point 8, a current may be abnormally flow when a surface of the fixed contact point 2 or the movable contact point 8b is stained with foreign substances and carbon may be deposited on the surfaces of the fixed contact point 2 and the movable contact point 8, causing contact defects after they are used for a long time.

In addition, impacts or metal fatigues between the fixed contact point 2 and the movable contact point 8 may deform the contact points 2 and 8, causing contact defects.

Moreover, according to the conventional thermostat, since an electronic product has one or more mechanism parts whose operations are controlled based on temperature, a thermostat for controlling the operation of the electronic product needs to be separately installed at input terminals of the mechanical parts to form the circuit of the electronic product. In particular, two or more thermostats may be preferably applied to a temperature keeping electric heater.

Accordingly, as the number of thermostats increases, manufacturing costs also increase and the circuit is made relatively complex.

Furthermore, since the thermostat 10 has a single switching section (including the fixed contact point 2 and the movable contact point 8), the contact points 2 and 8 within the thermostat 10 may be fused, in which case the contact points 2 and 8 may not be opened during the operation of the bimetal 6 or the operation point may be changed due to the metal fatigues of the bimetal 6 itself or an intrinsic overheating preventing function may not be achieved due to an undesirable situation. This phenomenon causes damage to the electrical product or a fire due to overheating.

That is, since the conventional thermostat does not disclose a structure of preventing a plurality of overheating (over-current) situations, it completely loses an intrinsic function of preventing an overheating (over-current) problem even when it is out of order or abnormally operated.

Therefore, the user that needed a plurality of dual blocking devices has undergone the inconvenience of constituting circuits and parts separately.

Meanwhile, the conventional dual blocking device may cause an undesirable situation due to its complex structure and process, deteriorating reliability and productivity.

### SUMMARY OF THE INVENTION

The prevent invention has been made in an effort to solve the above-described problems associated with the prior art, and an object of the present invention is to provide a thermostat that controls an operation of simultaneously blocking a plurality of input terminals.

It is another object of the present invention to provide a thermostat that has two fixed contact points and two movable contact points such that an over-current is blocked by one of the contact points even if a current cannot flow through the remaining one of the contact points.

It is still another object of the present invention to provide a thermostat that prevents damage to an electrical device and a fire due to overheating by blocking overheating twice.

It is yet another object of the present invention to provide a thermostat that ensures safe flow and blocking of a current.

According to an aspect of the present invention for achieving the above object, there is provided a thermostat comprising: a housing; first and second switching sections installed within the housing; a bimetal installed within the housing to electrically insulate the first and second switching sections at a predetermined temperature; and upper and lower caps covering upper and lower opened ends of the housing.

The first and second switching sections may include: first and second conductive pins installed within the housing; first and second connecting terminals coupled to the first and second conductive pins and protruding to the outside of the housing; a fixed plate coupled to the first conductive pin; a movable plate coupled to the second conductive pin; and a pushing pin pushing the movable plate as the bimetal moves.

First and second fixed contact points may be formed in the fixed plate and first and second movable contact points corresponding to the first and second fixed contact points may be formed in the movable plate.

A cut-away portion may be formed between the first and second movable contact points.

The bimetal may have an elliptical shape and the curve of the bimetal may be reversed at a predetermined temperature.

A blocking member may be formed in the housing.

According to another aspect of the present invention, there is provided a thermostat comprising: a housing; first and second switching sections installed within the housing; a bimetal installed within the housing to electrically insulate the first and second switching sections at a predetermined temperature; a fixed terminal connecting the first and second switching sections in series to each other; and upper and lower caps converting upper and lower opened ends of the housing.

The second switching section may include: a first connecting terminal protruding to the outside of the housing; first and second conductive pins coupled to the first connecting terminal and the fixed terminal respectively; a fixed plate coupled to the first conductive pin; a movable plate coupled to the second conductive pin; and a pushing pin pushing the movable plate as the bimetal moves.

According to still another aspect of the present invention, there is provided a a thermostat comprising: a housing: a first switching section installed within the housing; a bimetal installed within the housing to electrically insulate the first switching section at a predetermined temperature; a second switching section installed within the housing; a fixed terminal connecting in series the first and second switching sections to each other; and upper and lower caps covering upper and lower opened ends of the housing.

The operation point of the second switching section may be set to be higher than the operation point of the first switching section.

The second switching section may include: a second connecting terminal protruding to the outside of the housing; first and second conductive pins coupled to the second connecting terminal and the fixed terminal; and a blocking member coupled between the first conductive pin and the second conductive pin.

The operation point of the blocking member may be set to be higher than the operation point of the bimetal.

The blocking member may include a temperature fuse.

The blocking member may include an overheating preventing unit.

The overheating preventing unit may include: a first plate connected to one of the first and second conductive pins and having a movable contact point; a second plate connected to the remaining one of the first and second conductive pins and having a fixed contact point; and a bimetal attached to the first plate to release electrical connection between the movable contact point and the fixed contact point when it is reversed at a predetermined temperature.

The first switching section may include: a first connecting terminal protruding to the outside of the housing; first and second conductive pins coupled to the first and second connecting terminal and the fixed terminal respectively; a fixed plate coupled to the first conductive pin; a movable plate coupled to the second conductive pin; and a pushing pin pushing the movable plate as the bimetal moves.

First and second fixed contact points may be formed in the fixed plate and first and second movable contact points corresponding to the first and second fixed contact points may be formed in the movable plate.

A cut-away portion may be formed between the first and second movable contact points.

The first and second switching sections may be installed on a same plate of the housing.

A partition wall may be formed in the housing.

According to the thermostat of the present invention, first and second switching sections can control an operation of blocking a plurality of input terminals simultaneously.

As a result, the operation of a plurality of device parts can be controlled.

Further, the thermostat according to the present invention has two fixed contact points and two movable contact points such that an over-current is blocked by one of the contact points even if a current cannot flow through the remaining one of the contact points.

Furthermore, the two contact points can reduce an impact applied to the contact points when the contact points contact with each other, thereby minimizing damage thereto.

In addition, the thermostat according to the present invention prevents damage to an electrical device and a fire due to overheating by blocking overheating twice.

That is, safe flow and blocking of a current can be guaranteed.

Moreover, when the thermostat according to the present invention fails to block overheating first, it can block overheating secondarily at a little higher temperature by setting the operation point of the second switching section to be higher than the operation point of the first switching section.

That is, overheating is secondarily blocked by setting the operation point of the blocking member to be higher than the operation point of the bimetal.

### BRIEF DESCRIPTION OF THE DRAWINGS

The above and other objects, features and advantages of the present invention will become more apparent to those of ordinary skill in the art by describing in detail an exemplary embodiment thereof with reference to the accompanying drawings, in which:

FIG. 1 is a sectional view illustrating a conventional thermostat;

FIG. 2 is a perspective view illustrating a thermostat according to the first embodiment of the present invention;

FIG. 3 is a sectional view taken along line a-a of FIG. 2;

FIG. 4 is a sectional view taken along line b-b of FIG. 2;

FIGS. 5A and 5B are plan views illustrating a fixed plate and a movable plate of FIG. 2;

FIG. 6 is a bottom perspective view illustrating a thermostat according to the second embodiment of the present invention;

FIG. 7 is a perspective view illustrating a thermostat according to the second embodiment of the present invention;

FIG. 8 is a sectional view taken along line a-a of FIG. 7;

FIG. 9 is a sectional view taken along line b-b of FIG. 7 according to one embodiment of the present invention;

FIG. 10 is a sectional view taken along line b-b of FIG. 7 according to another embodiment of the present invention;

FIGS. 11A and 11B are plan views illustrating a fixed plate and a movable plate of FIG. 7; and

FIG. 12 is an exploded perspective view illustrating a thermostat according to another embodiment of the present invention.

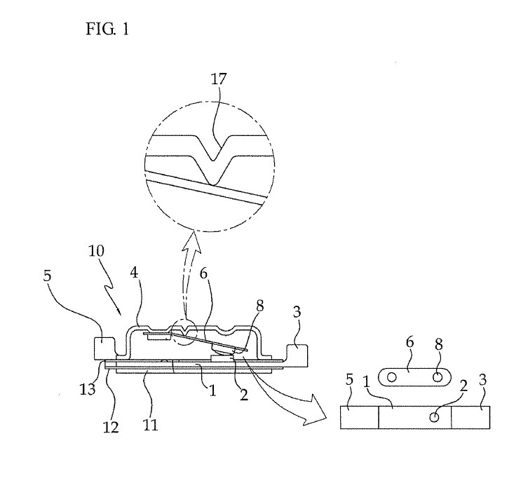

### DETAILED DESCRIPTION OF EXEMPLARY EMBODIMENTS

Hereinafter, exemplary embodiments of the present invention will be described below in detail with reference to the accompanying drawings.

### First Embodiment

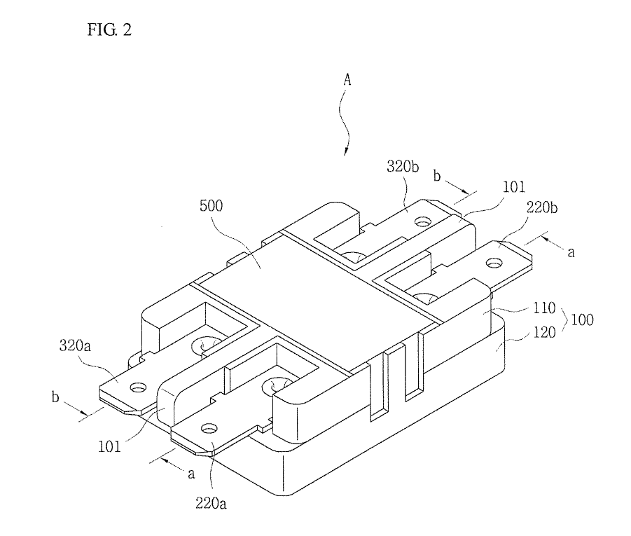

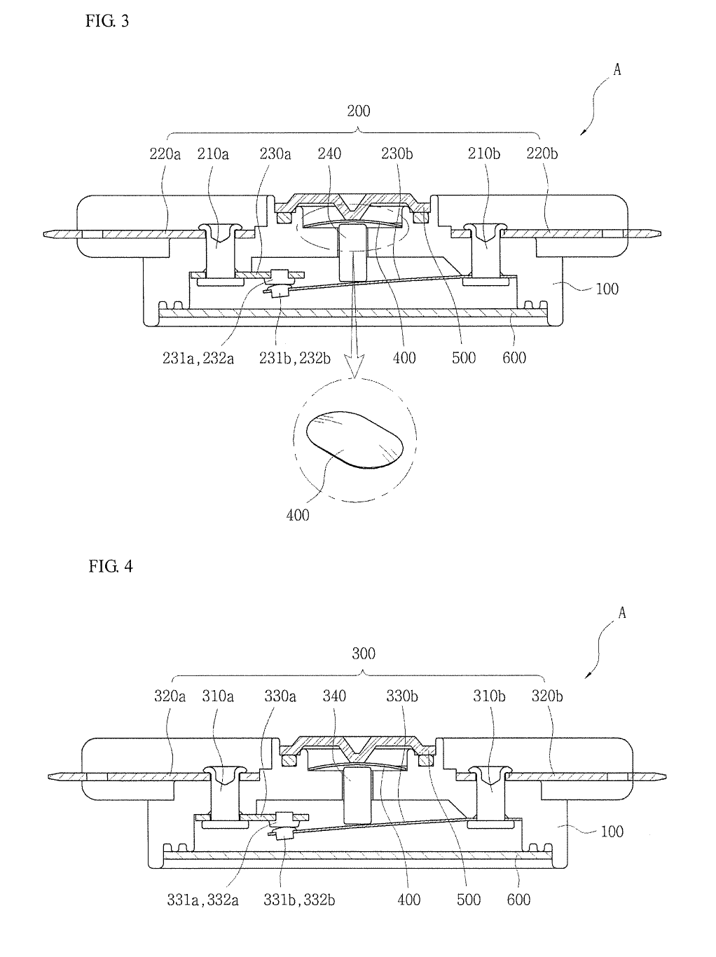

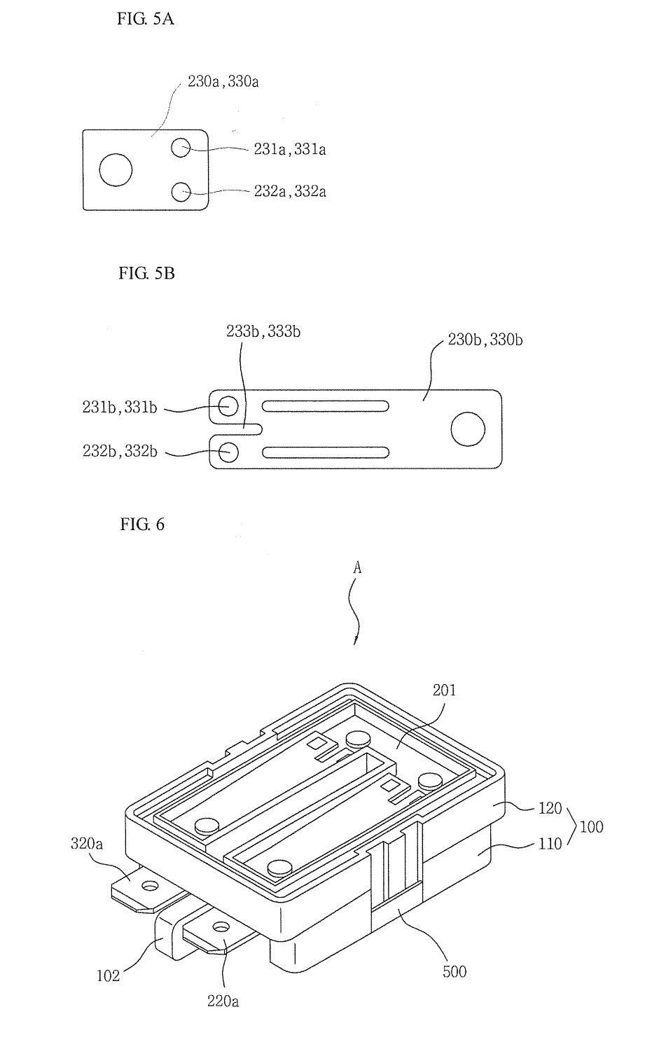

FIG. 2 is a perspective view illustrating a thermostat according to the first embodiment of the present invention. FIG. 3 is a sectional view taken along line a-a of FIG. 2. FIG. 4 is a sectional view taken along line b-b of FIG. 2. FIGS. 5A and 5B are plan views illustrating a fixed plate and a movable plate of FIG. 2.

As illustrated in FIGS. 2 to 5, the thermostat A according to the first embodiment of the present invention includes a housing 100, first and second switching sections 200 and 300 installed within the housing 100, and bimetals 400 installed within the housing 100 to electrically insulate the first and second switching sections 200 and 300 at a predetermined temperature, and upper and lower caps 500 and 600 covering upper and lower opened ends of the housing 100.

First, the housing 100 includes an upper body 110 and a lower body 120, and the first and second switching sections 200 and 300, the bimetals 400, and the upper and lower caps 500 and 600 are installed between the upper body 110 and the lower body 120.

The first switching section 200 includes first and second conductive pins 210a and 210b installed within the housing 100, first and second connecting terminals 220a and 220b coupled to the first and second conductive pins 210a and 210b and protruding to the outside of the housing 100, a fixed plate 230a coupled to the first conductive pin 210a, a movable plate 230b coupled to the second conductive pin 210b, and a pushing pin 240 pushing the movable plate 230b as the bimetal 400 moves upward and downward.

The fixed plate 230a has first and second fixed contact points 231a and 232a and the movable plate 230b has first and second movable contact points 231b and 232b corresponding to the first and second fixed contact points 231a and 232a.

Meanwhile, a cut-away portion 233b is formed between the first and second movable contact points 231b and 232b to maximally radiate the heat, which is generated due to the contact resistance when the movable contact points and the fixed contact points contact with each other, into the inner space of the housing 100. Moreover, the first and second movable contact points 231b and 232b may be individually operated by the cut-away portion 233b.

The second switching section 300 includes first and second conductive pins 310a and 310b installed within the housing 100, first and second connecting terminals 320a and 320b coupled to the first and second conductive pins 310a and 310b and protruding to the outside of the housing 100, a fixed plate 330a coupled to the first conductive pin 310, a movable plate 330b coupled to the second conductive pin 310b, and a pushing pin 340 pressing the movable plate 330b as the bimetal 400 moves upward and downward.

The fixed plate 330a has first and second fixed contact points 331a and 332a and the movable plate has first and second movable contact points 331b and 332b corresponding to the first and second fixed contact points 331a and 332a.

Meanwhile, a cut-away portion 333b is formed between the first and second movable contact points 331b and 332b to maximally radiate the heat, which is generated by a contact resistance when the movable contact points 331b and 332b and the fixed contact points 331a and 332a contact with each other, into a space. Moreover, the first and second movable contact points 331b and 332b can be individually operated by the cut-away portion 333b.

The bimetal 400 has an elliptical shape and its curve is reversed at a predetermined temperature. Moreover, the bimetal 400 pushes the pushing pins 240 and 340 of the switching sections 200 and 300 when its curve is reversed.

Accordingly, the first and second switching sections 200 and 300 may be turned on or off simultaneously by the bimetal 400 whose curve is reversed at a predetermined temperature.

As a result, the thermostat A according to the first embodiment of the present invention can control the operation of a plurality of input terminals.

Meanwhile, a partition wall 101 is formed within the housing 100 to separate the first and second connecting terminals 220a and 220b of the first switching section 200 and the first and second connecting terminals 320a and 320b of the second switching section 300, and prevent a short circuit between them.

### Second Embodiment

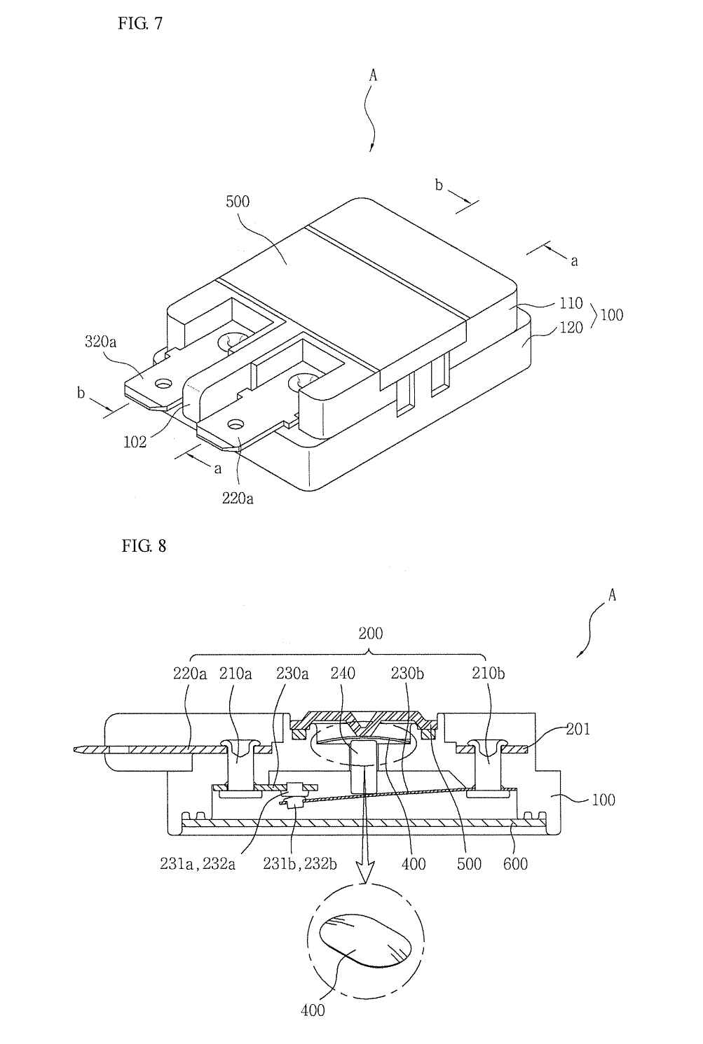

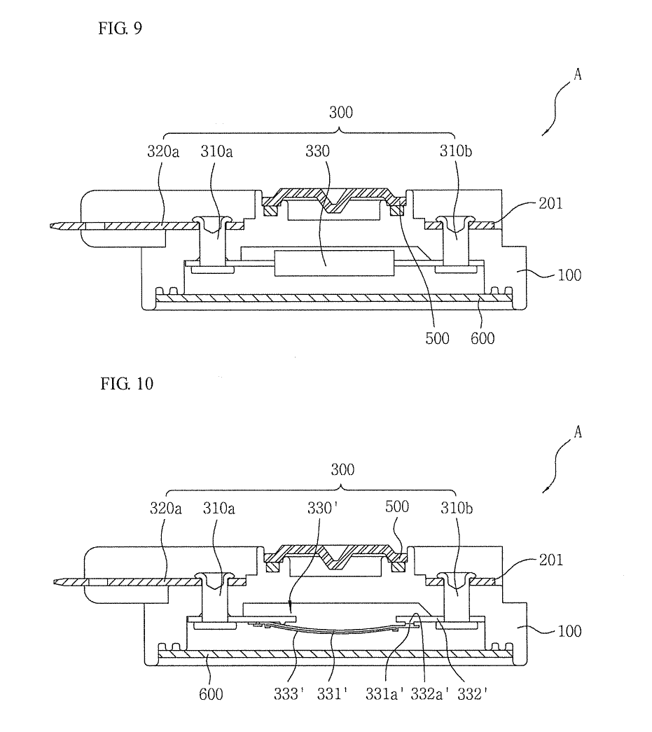

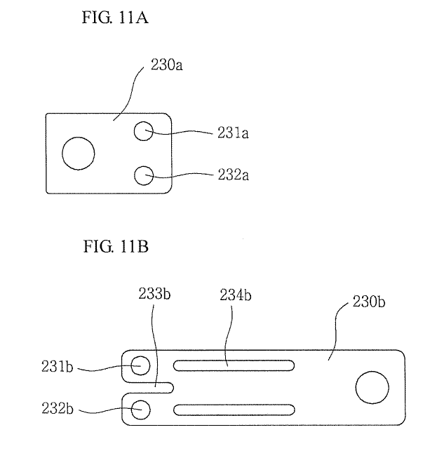

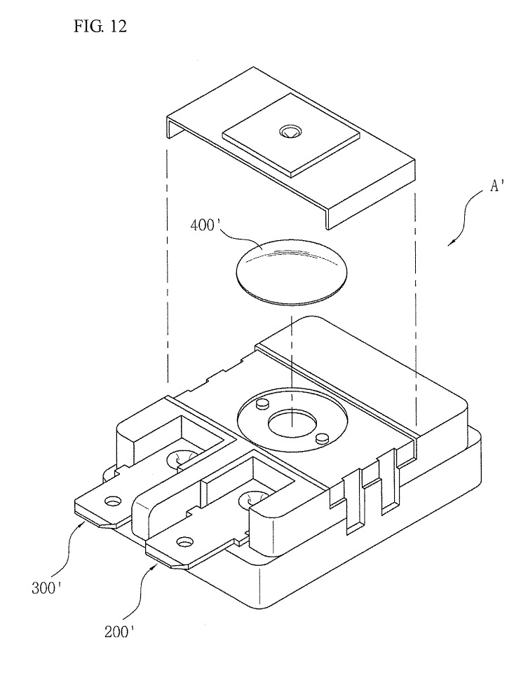

FIG. 6 is a bottom perspective view illustrating a thermostat according to the second embodiment of the present invention. FIG. 7 is a perspective view illustrating a thermostat according to the second embodiment of the present invention. FIG. 8 is a sectional view taken along line a-a of FIG. 7. FIG. 9 is a sectional view taken along line b-b of FIG. 7 according to one embodiment of the present invention. FIG. 10 is a sectional view taken along line b-b of FIG. 7 according to another embodiment of the present invention. FIGS. 11A and 11B are plan views illustrating a fixed plate and a movable plate of FIG. 7. FIG. 12 is an exploded perspective view illustrating a thermostat according to another embodiment of the present invention.

As illustrated in FIGS. 6 to 11, the thermostat A according to the second embodiment of the present invention includes a housing 100, a first switching section 200 installed within the housing 100, and a bimetal 400 installed within the housing 100 to electrically insulate the first switching section 200 at a predetermined temperature, a second switching section 300 installed within the housing 100, a fixed terminal 201 installed within the housing 100 to connect the first switching section 200 and the second switching section 300 in series, and upper and lower caps 500 and 600 covering upper and lower opened ends of the housing 100.

First, the housing 100 includes an upper body 110 and a lower body 120 and the first and second switching sections 200 and 300, the bimetal 400, and the upper and lower cap 500 and 600 are installed between the upper body 110 and the lower body 120.

The first and second switching sections 200 and 300 are installed on the same plane of the housing 100.

In addition, the operation point of the second switching section 300 is set to be higher than that of the first switching section 200. That is, if the first switching section 200 fails to prevent overheating, the second switching section 300 secondarily prevents overheating at a little higher temperature. Accordingly, a current may flow or be blocked more safely. The detailed description thereof will be described later.

The first switching section 200 includes a first connecting terminal 220a protruding to the outside of the housing 100, first and second conductive pins 210a and 210b coupled to the first connecting terminal 220a and the fixed terminal 201 respectively, a fixed plate 230a coupled to the conductive pin 210a, a movable plate 230b coupled to the second conductive pin 210b, and a pushing pin 240 pushing the movable plate 230b as the bimetal 400 moves.

The fixed plate 230a has first and second fixed contact points 231a and 232a and the movable plate 230b has first and second movable contact points 231b and 232b corresponding to the first and second fixed contact points 231a and 232a.

Meanwhile, a cut-away portion 233b is formed between the first and second movable contact points 231b and 232b to maximally radiate the heat, which is generated due to the contact resistance when the movable contact points and the fixed contact points contact with each other, into the inner space of the housing. Moreover, the first and second movable contact points 231b and 232b may be individually operated by the cut-away portion 233b.

A reinforcing rib 234b is formed in the movable plate 230b to prevent deformation of the movable plate 230b due to impacts and accumulated metal fatigues.

The bimetal 400 has an elliptical shape and its curve is reversed at a predetermined temperature. Moreover, the bimetal 400 pushes the pushing pin 240 of the first switching section 200 when its curve is reversed.

Accordingly, the first switching section 200 may be turned on or off simultaneously by the bimetal 400 whose curve is reversed at a predetermined temperature.

Meanwhile, if an overheating (over-current) problem occurs due to an abnormal operation of the first switching section 200 or the bimetal 400, an electrical device may be damaged or a fire may be caused due to overheating. The second switching section 300 was suggested to avoid this problem.

The second switching section 300 includes a second connecting terminal 320a protruding to the outside of the housing 100, first and second conductive pins 310a and 310b coupled to the second connecting terminal 320a and the fixed terminal 201 respectively, and a blocking member 330 coupled between the first conductive pin 310a and the second conductive pin 310b.

The operation point of the blocking member 330 is set to be higher than that of the bimetal 400. Accordingly, if the bimetal 400 fails to prevent overheating at the first stage, the blocking member 330 prevents overheating secondarily at a little higher temperature, thereby enhancing safety.

Referring to FIG. 9, the blocking member 330 includes a temperature fuse. The temperature fuse is broken at a predetermined temperature (a temperature higher than the operation point of the bimetal 400) to completely block a current.

Such a temperature fuse is well known in the art, and a detailed description thereof will be omitted.

The blocking member 330′ may be an overheating preventing unit as illustrated in FIG. 10.

The overheating preventing unit includes a first plate 331′ connected to one of the first and second conductive pins 310a and 310b and having a movable contact point 331a′, a second plate 332′ connected to the remaining one of the first and second conductive pins 310a and 310b and having a fixed contact point 332a′, and a bimetal 333′ attached to the first plate 331′ and reversed a predetermined temperature to release electrical connection between the movable contact point 331a′ and the fixed contact point 332a′.

That is, according to the overheating preventing unit, the current of the second switching section 300 is blocked by the bimetal 333′ whose curve is reversed at a predetermined temperature (a temperature higher than the operation point of the bimetal 400).

Moreover, it is preferable that the overheating preventing unit is grounded such that if temperature decreases after overheating (over-current) is stabilized by blocking a current at a predetermined temperature, the current flows again.

Meanwhile, various types of overheating preventing units may be used in addition to the above-mentioned one.

Thus, overheating is prevented twice by the first and second switching sections 200 and 300 connected in series to each other, thereby enhancing safety.

Meanwhile, a partition wall 102 is formed in the housing 100 to separate the first connecting terminal 220a of the first switching section 200 and the second connecting terminal 320a of the second switching section 300 and prevent a short circuit between them.

The thermostat A′ of FIG. 12 according to another embodiment of the present invention has a configuration in which first and second switching sections 200′ and 300′ connected in series to each other are electrically blocked at a predetermined temperature by reversing the curve of a bimetal 400′, and since the first and second switching sections 200′ and 300′ have the same structures and operations as those of the aforementioned first switching section 200, a detailed description thereof will be omitted.

That is, the first and second switching sections 200′ and 300′ blocks currents at a same temperature using the bimetal 400′.

It will be apparent to those skilled in the art that various modifications can be made to the above-described exemplary embodiment of the present invention without departing from the spirit or scope of the invention. Thus, it is intended that the present invention covers all such modifications provided they come within the scope of the appended claims and their equivalents.

For example, although the first and second switching sections of the thermostat A according to the second embodiment of the present invention are connected in series to each other, they may be connected to input terminals of a plurality of device parts respectively to control the operation.

What is claimed is:

1. A thermostat comprising:
a housing;
first and second switching sections installed within the housing;
a bimetal installed within the housing to electrically insulate the first and second switching sections at a predetermined temperature; and
upper and lower caps covering upper and lower opened ends of the housing.

2. The thermostat of claim 1, wherein the first and second switching sections include:
first and second conductive pins installed within the housing;
first and second connecting terminals coupled to the first and second conductive pins and protruding to the outside of the housing;
a fixed plate coupled to the first conductive pin;
a movable plate coupled to the second conductive pin; and
a pushing pin pushing the movable plate as the bimetal moves.

3. The thermostat of claim 2, wherein first and second fixed contact points are formed in the fixed plate and first and second movable contact points corresponding to the first and second fixed contact points are formed in the movable plate.

4. The thermostat of claim 3, wherein a cut-away portion is formed between the first and second movable contact points.

5. The thermostat of claim 1, wherein the bimetal has an elliptical shape and the curve of the bimetal is reversed at a predetermined temperature.

6. The thermostat of claim 1, wherein a partition wall is formed in the housing.

7. A thermostat comprising:
a housing;
first and second switching sections installed within the housing;
a bimetal installed within the housing to electrically insulate the first and second switching sections at a predetermined temperature;
a fixed terminal connecting the first and second switching sections in series to each other; and
upper and lower caps converting upper and lower opened ends of the housing.

8. The thermostat of claim 7, wherein the second switching section includes:
a first connecting terminal protruding to the outside of the housing;
first and second conductive pins coupled to the first connecting terminal and the fixed terminal respectively;
a fixed plate coupled to the first conductive pin;
a movable plate coupled to the second conductive pin; and
a pushing pin pushing the movable plate as the bimetal moves.

9. A thermostat comprising:
a housing:
a first switching section installed within the housing;
a bimetal installed within the housing to electrically insulate the first switching section at a predetermined temperature;
a second switching section installed within the housing;
a fixed terminal connecting in series the first and second switching sections to each other; and
upper and lower caps covering upper and lower opened ends of the housing.

10. The thermostat of claim 9, wherein the operation point of the second switching section is set to be higher than the operation point of the first switching section.

11. The thermostat of claim 10, wherein the second switching section includes:
a second connecting terminal protruding to the outside of the housing;
first and second conductive pins coupled to the second connecting terminal and the fixed terminal; and
a blocking member coupled between the first conductive pin and the second conductive pin.

12. The thermostat of claim 11, wherein the operation point of the blocking member is set to be higher than the operation point of the bimetal.

13. The thermostat of claim 12, wherein the blocking member includes a temperature fuse.

14. The thermostat of claim 12, wherein the blocking member includes an overheating preventing unit.

15. The thermostat of claim 14, wherein the overheating preventing unit includes:
a first plate connected to one of the first and second conductive pins and having a movable contact point;
a second plate connected to the remaining one of the first and second conductive pins and having a fixed contact point; and
a bimetal attached to the first plate to release electrical connection between the movable contact point and the fixed contact point when it is reversed at a predetermined temperature.

16. The thermostat of claim 7, wherein the first switching section includes:
a first connecting terminal protruding to the outside of the housing;
first and second conductive pins coupled to the first and second connecting terminal and the fixed terminal respectively;
a fixed plate coupled to the first conductive pin;
a movable plate coupled to the second conductive pin; and
a pushing pin pushing the movable plate as the bimetal moves.

17. The thermostat of claim 9, wherein the first switching section includes:
a first connecting terminal protruding to the outside of the housing;
first and second conductive pins coupled to the first and second connecting terminal and the fixed terminal respectively;
a fixed plate coupled to the first conductive pin;
a movable plate coupled to the second conductive pin; and
a pushing pin pushing the movable plate as the bimetal moves.

18. The thermostat of claim 16, wherein first and second fixed contact points are formed in the fixed plate and first and second movable contact points corresponding to the first and second fixed contact points are formed in the movable plate.

19. The thermostat of claim 17, wherein first and second fixed contact points are formed in the fixed plate and first and second movable contact points corresponding to the first and second fixed contact points are formed in the movable plate.

20. The thermostat of claim 18, wherein a cut-away portion is formed between the first and second movable contact points.

21. The thermostat of claim 19, wherein a cut-away portion is formed between the first and second movable contact points.

22. The thermostat of claim 7, wherein the first and second switching sections are installed on a same plate of the housing.

23. The thermostat of claim 9, wherein the first and second switching sections are installed on a same plate of the housing.

24. The thermostat of claim 7, wherein a partition wall is formed in the housing.

25. The thermostat of claim 9, wherein a partition wall is formed in the housing.
